(19) United States
(12) Patent Application Publication
(10) Pub. No.: US 2019/0291314 A1
(43) Pub. Date: Sep. 26, 2019

(54) POLYMER FOAM PROCESSING INCLUDING DIFFERENT TYPES OF BLOWING AGENT

(71) Applicant: Trexel, Inc., Wilmington, MA (US)

(72) Inventors: Samuel Edward Dix, Newton, NH (US); Levi A. Kishbaugh, Groveland, MA (US)

(73) Assignee: Trexel, Inc., Wilmington, MA (US)

(21) Appl. No.: 15/926,882

(22) Filed: Mar. 20, 2018

(51) Int. Cl. B29C 44/42; B29C 44/34; B29C 44/60

(52) U.S. Cl. CPC B29C 44/422; B29C 44/60; B29C 44/3453; B29C 44/3449

(57) ABSTRACT

Injection molding methods used to form polymeric foam articles (e.g., microcellular foam articles) are described herein.

### FIELD

The present invention relates generally to polymeric foam processing methods and related articles and more particularly to injection molding methods that use different blowing agent types and related injection molded polymeric foam articles.

### BACKGROUND

Polymeric foams include a plurality of voids, also called cells, in a polymer matrix. A number of techniques for processing polymeric material foams utilize an extruder which plasticates polymeric material by the rotation of a screw within a barrel. In general, polymeric foam processes introduce a blowing agent into fluid polymeric material within the extruder. The mixture of blowing agent and polymeric material may be processed (e.g., injection molded) to form the desired polymeric foam article.

### SUMMARY OF THE INVENTION

Injection molding methods and related polymeric foam articles are described herein. In one aspect, a method of molding a microcellular foam article is provided. The method comprises conveying a mixture comprising polymeric material and a chemical blowing agent in a downstream direction in a barrel of an extruder. The chemical blowing agent is decomposable to form carbon dioxide and is present in an amount between 0.20 and 3.00 weight percent based on the total weight of polymeric material. The method further comprises introducing a physical blowing agent comprising nitrogen into the mixture. The nitrogen is present in an amount between 0.025 and 1.50 weight percent based on the total weight of polymeric material. The method further comprises injecting the mixture into a mold cavity of a mold and recovering an injection molded microcellular foam article from the mold cavity.

In one aspect, a method of molding a microcellular foam article is provided. The method comprises conveying a mixture comprising polymeric material and a chemical blowing agent in a downstream direction in a barrel of an extruder. The chemical blowing agent is decomposable to form carbon dioxide. The method further comprises introducing a physical blowing agent comprising nitrogen into the mixture and injecting the mixture into a mold cavity of a mold and recovering an injection molded microcellular foam article from the mold cavity. The article has a thickness of less than 3 mm, a skin thickness of greater than 25% of the thickness of the article, and a void volume percentage of between 2% and 15%.

In one aspect, an injection molded microcellular foam article is provided. The article comprises a semi-crystalline polymeric material. The article has an average cell size of less than 100 microns, a thickness of less than 5 mm, a skin thickness of greater than 25% of the thickness, a void volume percentage of between 2 and 15% and a percentage elongation between 5% and 200%.

Other aspects and features will become apparent from the following detailed description of the invention when considered in conjunction with the accompanying drawings.

### BRIEF DESCRIPTION OF THE DRAWINGS

FIG. 1 shows an embodiment of a polymer foam processing system which may be used along with methods described herein.

### DETAILED DESCRIPTION OF THE INVENTION

Injection molding methods used to form polymeric foam articles (e.g., microcellular foam articles) are described herein. The methods involve introducing two different types of blowing agent into polymeric material to form a blowing agent and polymeric material mixture. For example, the blowing agent types may include a chemical blowing agent (e.g., decomposable to form carbon dioxide) and a physical blowing agent (e.g., nitrogen). The mixture of polymeric material and blowing agent may be processed in an extruder (e.g., to form a single-phase solution) and injected into a mold. An injection molded polymeric foam article may be recovered by opening the mold. As described further below, the inventors have appreciated that using certain amounts of chemical blowing agent and physical blowing agent can enable of production of high quality injection molded foam articles which may have desirable characteristics including one or more of the following: small cell sizes, thick skins and high elongations. Such methods and articles may be useful, for example, for a variety of consumer and industrial goods including automotive components, packaging and/or other injection molded articles.

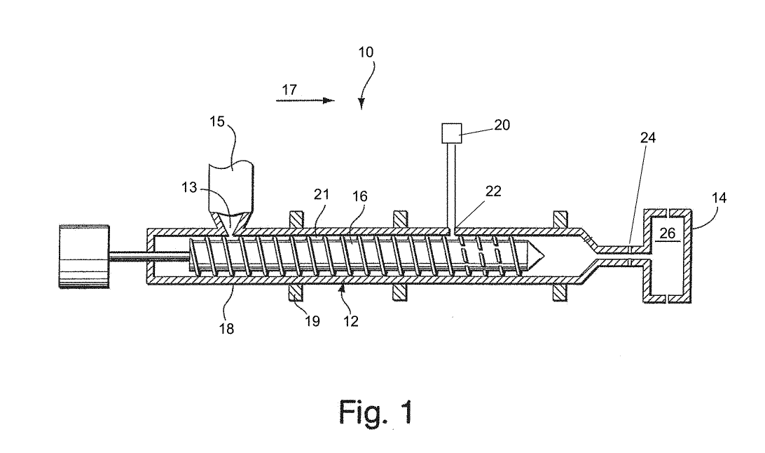

FIG. 1 illustrates an embodiment of an injection molding system 10 which may be used in methods described herein. In this embodiment, the injection molding system includes an extruder 12 and a mold 14. As shown, a hopper 15 provides polymeric material (e.g., in the form of pellets) to the extruder. The chemical blowing agent (e.g., in the form of pellets, particles, powder, liquid) and other additives (e.g., nucleating agents, fillers, colorants and the like) may also be introduced into the extruder via the hopper or otherwise. The extruder includes a screw 16 designed to rotate within a barrel 18 to process the polymeric material. Heat (e.g., provided by heaters 19 on the extruder barrel) and shear forces (e.g., provided by the rotating screw) act to melt the polymeric material to form a fluid polymeric stream which is conveyed in a downstream direction 17 by rotation of the screw. Such heat and shear forces also cause the chemical blowing agent to react (e.g., by decomposing) to form carbon dioxide which may be present in the fluid stream in the supercritical state within the extruder.

In the illustrated embodiment, a blowing agent introduction system 18 includes a physical blowing agent source 20 that is connected to one or more port(s) 22 in the extruder. Physical blowing agent (e.g., nitrogen) is introduced from the source into the fluid stream which becomes a mixture comprising polymeric material and the two types of blowing agent. The mixture may be further mixed as it is conveyed downstream within the extruder. In some embodiments, the mixture is a single-phase solution with the carbon dioxide (from the chemical blowing agent) and nitrogen being dissolved in the polymeric material prior to injection into the mold. In the illustrated embodiment, a valve 24 is arranged between the outlet of the extruder and the inlet of the mold. The mixture (e.g., single-phase solution) may be accumulated downstream of the screw within the extruder causing the screw to retract in an upstream direction within the barrel. At a suitable time, the screw stops retracting and rotating, and may be forced downstream to inject the mixture into a cavity 26 of the mold when valve 24 opens. The mixture is subjected to a pressure drop during injection which nucleates a large number of cells and a polymer foam article is formed in the mold. The screw begins to rotate once again and the method is typically repeated to produce additional foam articles.

It should be understood that polymer foam processing system may include a number of conventional components not illustrated in the FIGURE. For example, the system may include a control system which contributes to controlling the operation of different components such as the operation of the blowing agent metering system, rotation and movement of the screw, as well as the opening and closing of valves, amongst other operations.

In general, methods described herein may utilize any suitable chemical blowing agent capable of producing carbon dioxide under conditions in the extruder. The chemical blowing agent may undergo a reaction (e.g., a decomposition reaction) to form carbon dioxide upon being heated in the extruder. Suitable chemical blowing agents may include acids and/or alkalis. In some embodiments, suitable chemical blowing agent may comprise citric acid, sodium bicarbonate, monosodium citrate, dinitroso pentamethylenetetramine (DPT), oxybis (benzenesulfonyl hydrazide) (OBSH), p-toluenesulfonyl hydrazide (TSH), p-toluenesulfonyl semicarbazide (TSS) and calcium carbonate. It should be understood that the reactions that produce carbon dioxide may also produce other by-products which may be detectable in the final molded article.

As described herein, the inventors have appreciated that using certain amounts of chemical blowing agent (e.g., in combination with certain amounts of nitrogen physical blowing agent) may be preferred to form injection molding articles having desirable characteristics. For example, it may be preferred for the weight percentage of chemical blowing agent to be between about 0.20 and 3.00 weight percent based on the total weight of the polymeric material. In some of these embodiments, the weight percentage of the chemical blowing agent may be greater than or equal to 0.3 weight percent, may be greater than or equal to 0.35 weight percent or greater than or equal 0.50 weight percent based on the total weight of the polymeric material; and, in some embodiments, the weight percentage may be less than or equal to 2.0 weight percent and/or less than or equal to 0.5 weight percent. It should be understood that any suitable ranges defined by the above-noted minimum and maximum values may be used (e.g., between 0.30 weight percent and 2.00 weight percent; between 0.50 weight percent and 1.5 weight percent, etc.).

The chemical blowing agents used in the methods described herein may have any suitable form. In some cases, the chemical blowing agents may be in the form of pellets. In some cases, the chemical blowing agents may be in the form of particles. Other forms may also be also suitable such as flakes, powder or liquid. It should also be understood that the pellets and/or particles (or other forms) may include other components (e.g., non-reactive components) in addition to the chemical blowing agent. In some cases, the particles may have small particle sizes such as less than 10 micron and/or less than 1 micron. For example, some such chemical blowing agent particles have been described in U.S. Pat. No. 8,563,621 which is incorporated herein by reference in its entirety.

In general, the chemical blowing agents may be introduced into the polymeric material in the extruder in any suitable matter. As described above, in some embodiments, chemical blowing agents may be introduced into the extruder via the hopper. That is, the chemical blowing agent (e.g., in the form of pellets and/or particles) may be added to the hopper along with the polymeric material (e.g., in the of pellets) and other additives. It should be understood that the chemical blowing agents may also be introduced into the extruder downstream of the polymeric material (e.g., through another port in the barrel or otherwise).

As noted above, the methods described herein may utilize a blowing introduction system to introduce physical blowing agent (e.g., nitrogen) into the polymeric material. In some embodiments, the blowing agent introduction system may include a metering device (or system) 28 between the physical blowing agent source and the port(s). The metering device can be used to meter the nitrogen so as to control the amount of the nitrogen in the mixture within the extruder to maintain a level of nitrogen at a particular level. For example, the device meters the mass flow rate of the physical blowing agent. As described herein, the inventors have appreciated that using certain amounts of nitrogen physical blowing agent (e.g., in combination with certain amounts of chemical blowing agent) may be preferred to form injection molding articles having desirable characteristics such as small cell sizes, thick skins, high elongations and relatively high void volumes. For example, it may be preferred for the weight percentage of nitrogen physical blowing agent to be between about 0.025 and 1.50 weight percent based on the total weight of polymeric material. In some of these embodiments, the weight percentage of nitrogen may be greater than or equal to 0.05, greater than or equal to 0.1 weight percent, greater than or equal to 0.25 weight percent or greater than or equal 0.30 weight percent based on the total weight of polymeric material; and, in some embodiments, the weight percentage may be less than or equal to 0.75 weight percent, less than or equal to 1.00 weight percent and/or less than or equal to 1.25 weight percent based on the total weight of polymeric material. It should be understood that any suitable ranges defined by the above-noted minimum and maximum values may be used (e.g., between 0.25 weight percent and 1.00 weight percent; between 0.30 weight percent and 0.75 weight percent, etc.).

In some embodiments, the physical blowing agent is introduced discontinuously into the polymeric material. That is, physical blowing agent introduction into the polymeric material in the extruder may be stopped during a portion of the process. For example, it may be advantageous for the blowing agent flow to be stopped during at least a portion (and, in some cases, substantially all) of the time when the screw ceases to rotate and convey polymeric material in a downstream direction such as when polymeric material and blowing agent mixture is being injected into the mold. It should be understood that various techniques may be used to provide discontinuous blowing agent introduction. Suitable techniques, for example, have been described in U.S. Pat. Nos. 9,180,350; 8,137,600; 6,926,507; 6,616,434; and 6,602,063, each of which is incorporated herein by reference in its entirety.

As noted above, physical blowing agent may be introduced through one or more ports 22. In some embodiments, a single port is provided. In other embodiments, multiple ports may be provided. When multiple ports are present, the ports may be arranged at substantially the same axial position around the extruder barrel but at different radial positions; or, the ports may be arranged at different axial positions (e.g., one port is downstream the other port) along the extruder barrel.

In some embodiments, a blowing agent injector assembly may be positioned within the port(s). The injector assembly may include a plurality of small orifices through which physical blowing agent flows on its pathway into the polymeric material.

The blowing agent introduction system may include a valve (e.g., shut-off valve) arranged proximate to or at the port. In some embodiments, the valve may be a component of the blowing agent injector assembly. The valve may be opened to permit blowing agent to flow therepast (e.g., from the source into the polymeric material in the extruder) and closed to prevent blowing agent from flowing therepast (e.g., from the source into the polymeric material in the extruder).

As noted above, the extruder includes screw 16 designed to rotate within the barrel. The screw typically is configured to include different functional sections. For example, the screw may include a feed section, mixing section and metering section. The different functional sections may have different screw flight designs and/or different screw diameters. Such screw designs are known to those of ordinary skill in the art. In some embodiments, the screw includes a restriction element. The restriction element may be positioned upstream of the blowing agent port. The restriction element is designed to restrict the upstream flow therethrough of the polymeric and blowing agent mixture, for example, during a portion of an injection molding cycle (e.g., the injection step). Suitable screw sections, including restriction elements, have been described in commonly-owned U.S. Pat. Nos. 7,318,713 and 6,579,910 which are incorporated herein by reference in their entireties.

As described above, the methods described herein may involve forming a fluid stream in an extruder which comprises polymeric material and the two types of blowing agent (e.g., nitrogen introduced as a physical blowing agent and carbon dioxide from chemical blowing agent reactions). In some embodiments, the mixture is processed in the extruder to form a single-phase solution with the carbon dioxide (from the chemical blowing agent) and nitrogen being dissolved in the polymeric material prior to injection into the mold. It should be understood that, as used herein, such a single-phase solution is considered to be an example of a polymeric material and blowing mixture. It should also be understood that not all methods described herein involve formation of a single-phase solution and that certain methods may involve injection of a two-phase mixture (e.g., polymeric material and blowing agent) into the mold. It may be preferred in certain embodiments that produce microcellular foam articles, as described further below, to form a single-phase solution which is nucleated upon injection into the mold. Suitable processes for forming single-phase solutions and nucleating upon injection into the mold have been described in commonly-owned U.S. Pat. No. 6,884,823 which is incorporated herein by reference above in its entirety.

Any polymeric material suitable for forming polymeric foams may be used with the methods described herein. Such polymeric materials, in some cases, are thermoplastics which may be amorphous, semicrystalline, or crystalline materials. In some embodiments, semicrystalline or crystalline materials are preferred. Typical examples of polymeric materials used include polyolefins (e.g., polyethylene and polypropylene), styrenic polymers (e.g., polystyrene, ABS), fluoropolymers, polyamides, polyimides, polyesters, and/or mixtures of such polymeric materials. In some embodiments, polyolefin materials may be used. In some such embodiments, the polyolefin material may be a mixture of more than one type of olefin, or a mixture of one or more types of polyolefin and one or more types of non-polyolefin polymeric materials. The polymeric material used may depend upon the application in which the article is ultimately utilized.

In general, the polymeric foam articles have a certain cell size. In some embodiments, the methods described herein may be used to produce foam articles having a small cell size. For example, in some cases, the methods involve production of microcellular foam articles. The microcellular foam article may have an average cell size of less than 100 microns. In some cases, the microcellular foam articles have an average cell size of less than 75 microns. Average cell size may be determined by measuring a representative number of cells using microscopy (e.g., SEM) techniques. In some embodiments (including embodiments involving production of microcellular foam material), the cell size may vary across the thickness of the injection molded article. For example, the cell size at or near the center of the article may be larger than the cell size approaching edges of the article and/or edges of the foamed region of the article.

It should be understood that not all methods described herein involve producing microcellular foam and that, in some embodiments, articles having an average cell size of greater than 100 microns.

The injection molded polymeric foam articles may have a range of void volume percentages. As used herein, the void volume percentage is the percentage of the volume of an article occupied by voids. It can be measured by the following equation:

Void volume %=100×[1−(density of the polymer foam article/density of solid polymer)]

For example, if the foam article has a density of 0.85 g/cm³ and the solid polymer has a density of 1.0 g/cm³, then the percentage void volume is 15%. The particular void volume may depend upon the application. In some embodiments, the void volume percentage is relatively low. For example, the void volume percentage may be less than 20%, less than 15%, less than 12%, less than 10% or less than 5%. In some embodiments, the void volume may be greater than 2%; greater than 5%, greater than 8%, greater than 10% or greater than 15%. It should be understood that any suitable ranges defined by the above-noted minimum and maximum values may be used (e.g., between 2% and 15%, between 5% and 15%, between 8% and 12%, etc.).

In general, the injection molded polymeric foam articles may have any suitable wall thickness. As used herein, wall thickness refers to the predominant cross-sectional dimension across the thickness of the article. For example, the article thickness may be less than 5.0 mm, less than 3.0 mm, less than 2.5 mm, less than 2.0 mm or less than 1.0 mm. In some embodiments, the article thickness may be greater than 0.5 mm, greater than 1.0 mm or greater than 1.5 mm. It should be understood that any suitable ranges defined by the above-noted minimum and maximum values may be used (e.g., between 0.5 mm and 5 mm, between 0.5 mm and 3.0 mm, between 1.0 mm and 3.0 mm, etc.).

As described above, in some embodiments, the injection molded polymeric foam articles may have unfoamed skin region(s) extending from the exterior surfaces of the article (e.g., article surfaces that are in contact with the injection mold). The skin regions may surround (at least in part) a foamed interior region. The total skin thickness and/or percentage of total skin thickness compared to total wall thickness may be characterized using visual techniques (e.g., by eye and/or microscopy). The total skin thickness is the sum of the skin thicknesses across the cross-sectional thickness of the article.

In some embodiments, the total skin thickness may be greater than 100 microns, greater than 200 microns, greater than 250 microns, greater than 300 microns, greater than 400 microns or greater than 500 microns. In some embodiments, the total skin thickness may be less than 700 microns, less than 600 microns, less than 500 microns or less than 300 microns. It should be understood that any suitable ranges defined by the above-noted minimum and maximum values may be used (e.g., between 100 microns and 500 microns, between 250 microns and 700 microns, etc.).

In some embodiments, the percentage of total skin thickness compared to total wall thickness may be greater than 15%, greater than 25%, greater than 40%, greater than 50% or greater than 60%. In some embodiments, the percentage of total skin thickness compared to total wall thickness may be less than 70%, less than 50%, less than 40% or less than 25%. It should be understood that any suitable ranges defined by the above-noted minimum and maximum values may be used (e.g., between 25% and 70%, between 15% and 50%, etc.).

It should be understood that not all injection mold articles described herein have an identifiable skin. That is, such articles may comprise substantially entirely of a foamed structure.

The injection molded articles described herein can exhibit excellent properties including excellent mechanical properties such as high elongations. For example, the percent elongation at break (as measured by ASTM D638) may be greater than 5%, greater than 25%, greater than 50%, greater than 100%, or greater than 150%. In some embodiments, the percent elongation at break (as measured by ASTM D638) may be less than 200%, less than 150%, less than 100% or less than 50%. It should be understood that any suitable ranges defined by the above-noted minimum and maximum values may be used (e.g., between 5% and 200%, between 25% and 150%, etc.).

The desirable properties and characteristics enable the injection molded foam articles described herein to be used in a variety of applications. In particular, the articles may be used in a variety of consumer and industrial goods including automotive components and packaging.

The function and advantage of these and other embodiments of the present invention will be more fully understood from the examples below. The following example is intended to illustrate the benefits of the present invention, but does not exemplify the full scope of the invention and should not be considered limiting in this regard.

### Example

This example compares injection molded foam articles produced according to methods described herein which utilize two blowing agent types to injection molded foam articles produced using a single blowing agent and a solid article.

In general, injection molded foam samples were produced using polypropylene material and the blowing types noted in the table below. Sample 1 was a control produced with no blowing agent to form a solid polymeric material article (i.e., unfoamed article).

| | | | Void | Elongation | Core | Skin | Cell size | Cell density |
|---|---|---|---|---|---|---|---|---|
| | N₂ | CBA | Volume | (50 | Thick | Thick | (center) | (cells/ |
| Sample | (wt %) | (wt %) | (%) | mm/min) | (microns) | (microns) | (microns) | 1 mm²) |
| 1 | 0 | 0 | 0 | 179 | N/A | N/A | N/A | N/A |
| 2 | 0.50 | 0 | 8 | 21 | 1512 | 244 | 340 | 12 |
| 3 | 0 | 4 | 8 | 85 | 771 | 615 | 62.5 | 120 |
| 4 | 0.35 | 1.00 | 8 | 154 | 1247 | 376 | 70.1 | 150 |
| 5 | 0.50 | 1.00 | 8 | 156 | 1145 | 428 | 33.9 | 400 |
| 6 | 0.75 | 2.00 | 8 | 179 | 1293 | 353 | 35.09 | 625 |

The results show that samples produced using nitrogen blowing agent and chemical blowing agents (samples 4-6) generally had better elongation properties than samples produced with solely with nitrogen blowing agent (sample 2) and solely with chemical blowing agents (sample 3).

What is claimed is:

1. A method of molding a microcellular foam article comprising:
conveying a mixture comprising polymeric material and a chemical blowing agent in a downstream direction in a barrel of an extruder, wherein the chemical blowing agent is decomposable to form carbon dioxide and is present in an amount between 0.20 and 3.00 weight percent based on the total weight of polymeric material; and
introducing a physical blowing agent comprising nitrogen into the mixture, the nitrogen being present in an amount between 0.025 and 1.50 weight percent based on the total weight of polymeric material; and
injecting the mixture into a mold cavity of a mold; and
recovering an injection molded microcellular foam article from the mold cavity.

2. A method of molding a microcellular foam article comprising:
conveying a mixture comprising polymeric material and a chemical blowing agent in a downstream direction in a barrel of an extruder, wherein the chemical blowing agent is decomposable to form carbon dioxide;
introducing a physical blowing agent comprising nitrogen into the mixture; and
injecting the mixture into a mold cavity of a mold; and
recovering an injection molded microcellular foam article from the mold cavity, the article having a thickness of less than 5 mm, a skin thickness of greater than 25% of the thickness of the article, and a void volume percentage of between 2% and 15%.

3. The method of claim 1, wherein the microcellular foam article has an average cell size of less than 100 micron.

4. The method of claim 1, wherein the mixture is a single-phase solution comprising the polymeric material, nitrogen, and carbon dioxide prior to injection into the mold.

5. The method of claim 1, wherein the physical blowing agent comprising nitrogen blowing agent is present in an amount between 0.25 and 1.00 weight percent based on the total weight of the polymeric material.

6. The method of claim 1, wherein the physical blowing agent comprising nitrogen blowing agent is present in an amount between 0.30 and 0.75 weight percent based on the total weight of the polymeric material.

7. The method of claim 1, wherein the chemical blowing is present in an amount between 0.35 and 2.00 weight percent based on the total weight of the polymeric material.

8. The method of claim 1, wherein the chemical blowing is present in an amount between 0.50 and 1.50 weight percent based on the total weight of the polymeric material′.

9. The method of claim 1, wherein the chemical blowing agent comprises an acid and an alkali to produce carbon dioxide.

10. The method of claim 1, wherein the chemical blowing agent is selected from the group consisting of citric acid, sodium bicarbonate, monosodium citrate, calcium carbonate and zinc stearate.

11. The method of claim 1, wherein the chemical blowing agent is added to the mixture as a separate ingredient.

12. The method of claim 1, wherein the microcellular foam article comprises a semi-crystalline polymer.

13. The method of claim 1, wherein the microcellular foam article has a percentage elongation between 5% to 200%.

14. The method of claim 1, wherein the microcellular foam article has a wall thickness of less than 3 mm.

15. The method of claim 1, wherein the microcellular foam article has a skin thickness and a wall thickness and the skin thickness is greater than 50% of the wall thickness.

16. The method of claim 1, wherein the microcellular foam article has a void volume percentage of between 2% and 15%.

17. The method of claim 1, wherein the skin thickness of the microcellular foam article is in a range of 250 to 600 microns.

18. An injection molded microcellular foam article comprising a semi-crystalline polymeric material, the article having an average cell size of less than 100 microns, a thickness of less than 5 mm, a skin thickness of greater than 25% of the thickness, a void volume percentage of between 2 and 15% and a percentage elongation between 5% and 200%.

19. The article of claim 18, wherein the microcellular foam article has a wall thickness of less than 3 mm.

20. The article of claim 18, wherein the microcellular foam article has a skin thickness and a wall thickness and the skin thickness is greater than 50% of the wall thickness.
